(19) United States
(12) Patent Application Publication
(10) Pub. No.: US 2004/0257803 A1
(43) Pub. Date: Dec. 23, 2004

(54) CEILING LIGHT ILLUMINATED DISPLAY

(75) Inventor: David N. Kermoade, Overland Park, KS (US)

Correspondence Address: HOVEY WILLIAMS LLP, 2405 GRAND BLVD., SUITE 400, KANSAS CITY, MO, 64108, US

(73) Assignee: BRILLIANT IDEAS AND DESIGN, LLC, Overland Park, KS (US)

(21) Appl. No.: 10/604,035

(22) Filed: Jun. 23, 2003

(51) Int. Cl. F21S 4/00

(52) U.S. Cl. 362/223; 362/404; 362/812

(57) ABSTRACT

A backlit display system including a main body which is formed from a single sheet of flexible light-transmissive material. The display system can be shifted from a compact, substantially flat collapsed position to an assembled position with minimal effort by simply folding the main body along predetermined bend lines. Once the main body is assembled, hooks can be attached to the ends of the main body, and the hooks used to couple the display system to a suspended ceiling under a light source. Graphical and/or textual information on or in the main body is illuminated by light emitted from the light source for easy viewing by persons traveling under the display system.

### BACKGROUND OF INVENTION

1. Field of the Invention

The present invention relates generally to lighted signs for displaying advertisements or other information. In another aspect, the invention concerns backlit display systems that can be mounted under conventional recessed light fixtures in suspended ceilings.

2. Description of the Prior Art

Various conventional systems exist for displaying illuminated information using light emitted from an existing recessed light fixture in a suspended ceiling. One such conventional display system utilizes a light-transmissive trough-shaped rigid body that is coupled under the light fixture by fasteners positioned around the upper edge of the trough-shaped body. Although this type of system is effective for utilizing existing light fixtures to illuminate the displayed information, a number of drawbacks are associated with utilizing a rigid body for the lighted display system. For example, the rigid body can be difficult and expensive to transport and store because of its bulk and weight. Thus, a collapsible display system would be preferred.

Existing collapsible display systems that utilize light from an existing recessed light fixture are typically formed of a relatively flimsy material that is bent or folded into a generally V-shaped trough. The V-shaped trough of such a display system typically extends completely across the light fixture and is attached to the ceiling supports on opposite sides of the light fixture. This type of display system has a number of drawbacks. For example, such a display system typically covers a substantial portion of the light fixture and can block an undesirably large amount of the light emitted by the light fixture. Further, in order to make the display system more structurally sound, this type of system requires a number of additional support members to be attached to the relatively flimsy material that makes up the body of the display system. The use of additional support structure can add significantly to the expense of the display system, and can add to the difficulty of assembling the system.

### SUMMARY OF INVENTION

It is, therefore, an object of the present invention to provide a backlit display system that is collapsible for easy storage and transportation.

A further object of the invention is to provide a backlit display system that is formed of a minimal number of relatively inexpensive components.

Another object of the invention is to provide a backlit display system that is structurally sound, but does not require the use of various additional structural supporting members.

Still another object of the invention is to provide a simple and inexpensive method of displaying information using a backlit display system that can readily be shifted between a collapsed configuration, where the size and thickness of the display system is minimized, and an assembled configuration, where the display system is configured to display illuminated information.

Yet another object of the invention is to provide a simple and inexpensive method of making a backlit display system.

It should be understood that the above-listed objects are only exemplary, and not all the objects listed above need be accomplished by the invention described and claimed herein.

Accordingly, in one embodiment of the present invention, there is provided a backlit display system comprising first and second light-transmissive side panels hingedly coupled to one another along a juncture, a first outer end panel hingedly coupled to one of the side panels proximate a first end of the juncture, and a second outer end panel hingedly coupled to one of the side panels proximate a second end of the juncture.

In another embodiment of the present invention, there is provided a method of displaying information comprising the steps of: (a) shifting a display system from a substantially collapsed configuration to an assembled configuration, with the assembled display system including a generally V-shaped trough and a pair of end panels hingedly coupled to generally opposite ends of the trough; and (b) mounting the assembled display system on a support structure surrounding a light fixture by fastening the end panels to the support structure.

In a further embodiment of the present invention, there is provided a method of making a backlit display system comprising the steps of: (a) providing a display body integrally formed from a substantially flat sheet of light-transmissive material, with the display body comprising a generally rectangular main panel and first and second end panels extending from generally opposite ends of the main panel; (b) folding the display body along a main bend line extending through the main panel to thereby manipulate the main panel into a generally V-shaped trough having a first side panel and a second side panel, with the first and second end panels extending from generally opposite ends of the trough; (c) folding the first and second end panels so that the first and second end panels extend substantially perpendicular to the first and second side panels; (d) using the first end panel to couple the first and second side panels to one another at one end of the trough; and (e) using the second end panel to couple the first and second side panels to one another at the other end of the trough.

### BRIEF DESCRIPTION OF DRAWINGS

A preferred embodiment of the present invention is described in detail below with reference to the attached drawing figures, wherein:

FIG. 1 is an isometric view of an inventive backlit display system that is mounted under a recessed light fixture of a suspended ceiling;

FIG. 2 is a top view of the main body of an inventive backlit display system in an unfolded configuration, particularly illustrating that the substantially flat main body can be folded along various bend lines which divide the main body into a variety of different structural components that give the body three dimensional size and support when folded in the prescribed manner;

FIG. 3 is a top view of the main body in a collapsed configuration, particularly illustrating the main body being folded in upon itself at a number of the bend lines so that the main body has a minimal size and thickness;

FIG. 4A is an isometric view of an inventive backlit display system in a partially assembled configuration, particularly illustrating one end of the display system being fully assembled and the opposite end of the display system being completely disassembled;

FIG. 4B is an isometric view of the backlit display system shown in FIG. 4A, particularly illustrating the manner in which an inside end panel is folded during assembly of the display system;

FIG. 4C is an isometric view of the backlit display system shown in FIG. 4B, particularly illustrating the manner in which an outside end panel and overlap tab are folded during assembly of the display system and also illustrating the manner in which a translucent sheet with an image printed thereon can be inserted into the display system;

FIG. 5 is an enlarged partially cut-away side view of an inventive backlit display system in an assembled configuration, particularly illustrating a hook that is attached to an end of the main body and used to support the main body under a light fixture; and

FIG. 6 is a partial sectional side view taken along line 6-6 in FIG. 5, particularly illustrating the manner in which the hook is coupled to the main body and the support member of the suspended ceiling.

### DETAILED DESCRIPTION

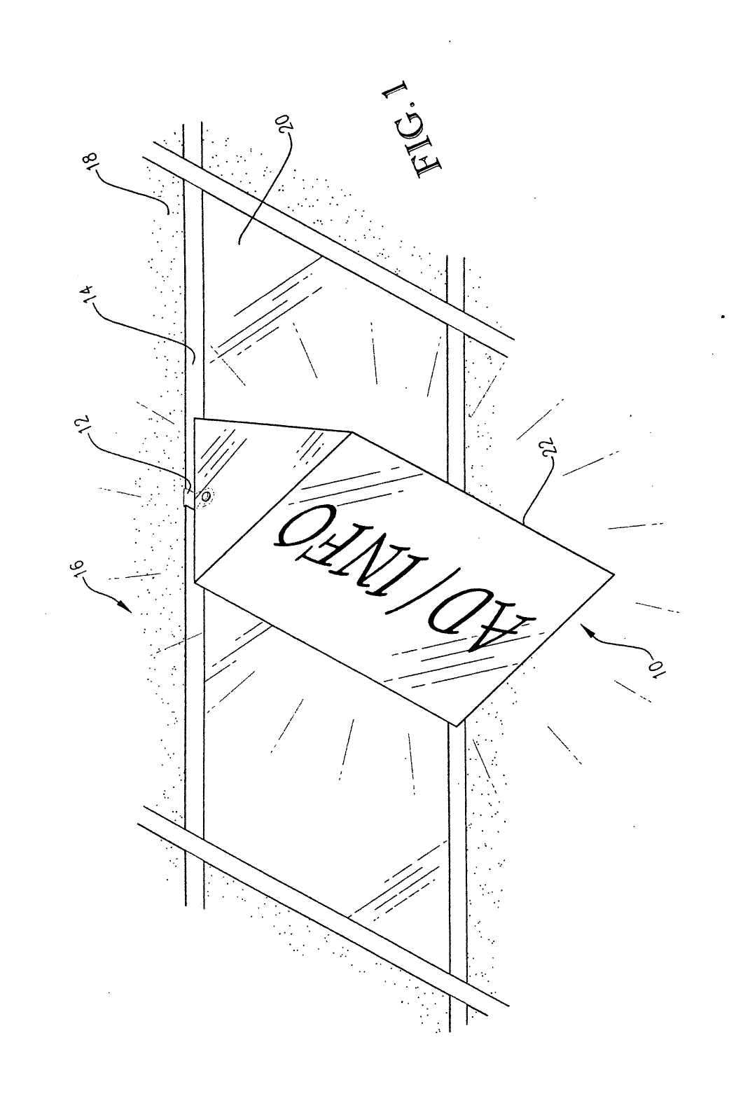

Referring initially to FIG. 1, a backlit display system 10 is illustrated in an assembled configuration. Display system 10 includes a hook 12 which is used to fasten display system 10 to a structural member 14 of a suspended ceiling 16. Suspended ceiling 16 can be any conventional suspended ceiling utilizing a grid of structural members 14 to support a plurality of ceiling panels 18 and a recessed light fixture 20. In general, display system 10 is a triangular-shaped trough with closed ends and an open top. The open top of display system 10 is positioned under a portion of light fixture 20 and allows light emitted from light fixture 20 to enter into display system 10 from above. The light in display system 10 can be used to illuminate advertisement or other information formed on/in a translucent portion of display system 10.

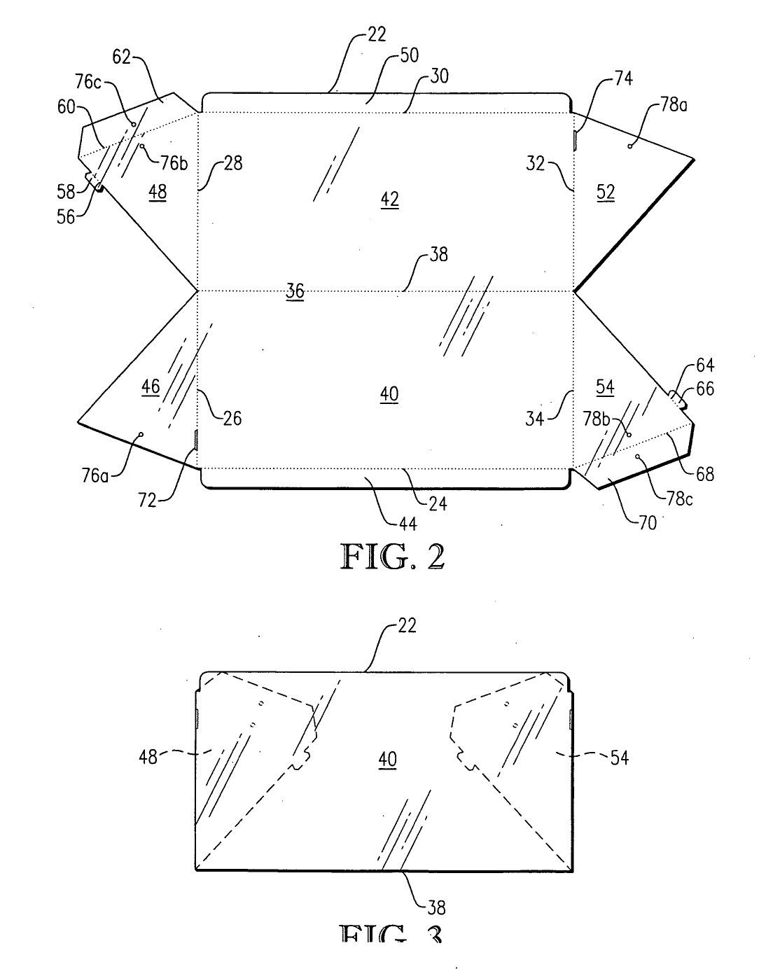

Referring to FIG. 2, a main body 22 of display system 10 is illustrated in a substantially flat, unfolded configuration. In a preferred embodiment of the present invention, main body 22 is formed from a single sheet of a thin, flexible, light-transmissive material. As used herein, the term “light-transmissive” shall denote any object/material that is not opaque. Most preferably, main body 22 is formed of a sheet of transparent synthetic resin material that is capable of being repeatedly folded (i.e., at least 20 times) along a bend line (thereby forming a “living hinge”) without causing cracking/fracturing of the material along the bend line. The shape of main body 22, shown in FIG. 2, can be made by simply stamping the sheet using a preformed die or cutting the sheet along a preformed template. Thus, main body 22 is formed of a relatively inexpensive material in a relatively inexpensive manner.

Referring again to FIG. 2, in order to form the assembled display system 10 (shown in FIG. 1), main body 22 must be folded along a number of bend lines. The bend lines represent living hinges between various substantially flat components/panels of main body 22 that are bent relative to one another. Thus, various components that are joined at bend lines are referred to herein as being “hingedly coupled” to one another. Bend lines 24,26,28,30,32,34 outline a generally rectangular main panel section 36 of main body 22. A main bend line 38 divides main panel section 36 into a first side panel 40 and a second side panel 42 and defines a living hinge junction between first and second side panels 40,42. Bend line 24 defines a living hinge junction between first side panel 40 and a first side flange 44. Bend line 26 defines a living hinge junction between first side panel 40 and a first inner end panel 46. Bend line 28 defines a living hinge junction between second side panel 42 and a first outer end panel 48. Bend line 30 defines a living hinge junction between second side panel 42 and a second side flange 50. Bend line 32 defines a living hinge junction between second side panel 42 and a second inner panel end 52. Bend line 34 defines a living hinge junction between first side panel 40 and a second outer end panel 54. A bend line 56 defines a living hinge junction between first outer end panel 48 and a first connection tab 58. A bend line 60 defines a living hinge junction between first outer end panel 48 and a first overlap tab 62. A bend line 64 defines a living hinge junction between second outer end panel 54 and a second connection tab 66. A bend line 68 defines a living hinge junction between second outer end panel 54 and a second overlap tab 70. A first slot 72 is defined in first inner end panel 46 adjacent bend line 26. A second slot 74 is defined in second inner end panel 52 adjacent bend line 32. First and second slots 72, 74 are adapted to releasably receive and hold first and second connection tabs 58,66, respectively, when main body 22 is in the fully assembled configuration (shown in FIG. 1). First inner end panel 46, first outer end panel 48, and first overlap tab 62 each define respective first openings 76a,b,c. Second inner end panel 52, second outer end panel 54, and second overlap tab 70 each define respective second openings 78a,b,c. When main body 22 is in the fully assembled configuration (as shown in FIG. 1), first openings 76a,b,c are substantially aligned with one another and second openings 78a,b,c are substantially aligned with one another.

Referring to FIG. 3, main body 22 is shown in a collapsed configuration where the size and thickness of main body 22 is minimized. When in the collapsed configuration, main body 22 can be easily stored and transported. Referring to FIGS. 2 and 3, in order to shift main body 22 from the unfolded configuration (shown in FIG. 2) to the collapsed configuration (shown in FIG. 3), first inner end panel 46 is pivoted relative to first side panel 40 along bend line 26 through an angle of about 180 degrees, first outer end panel 48 is pivoted relative to second side panel 42 along bend line 28 through an angle of about 180 degrees, second inner end panel 52 is pivoted relative to second side panel 42 along bend line 32 through an angle of about 180 degrees, second outer end panel 54 is pivoted relative to first side panel 40 along bend line 34 through an angle of about 180 degrees, and first side panel 40 is pivoted relative to second side panel 42 along main bend line 38 through an angle of about 180 degrees. As used herein, the term “about 180 degrees” shall denote 180 degrees plus or minus 15 degrees. In the above-described manner, the largest components of main body 22 are essentially folded in upon one another so that first and second inner and outer end panels 46,48,52,54 are disposed generally between first and second side panels 40, 42 when main body 22 is in the collapsed configuration (shown in FIG. 3). When main body 22 is in the collapsed configuration, it is preferred for the maximum thickness of main body 22 to be less than about 4 inches, more preferably less than about 2 inches, and most preferably less than 1 inch. Further, when main body 22 is in the collapsed configuration, it is preferred for the angle formed between first and second side panels 40,42, which are hingedly coupled to one another along bend line/junction 38, to be less than about 10 degrees, more preferably less than about 5 degrees, and most preferably less than 2 degrees.

Referring now to FIGS. 1 through 4, backlit display system 10 can be shifted from the collapsed configuration (shown in FIG. 3) to the assembled configuration (shown in FIG. 1) with minimal effort. The first step in shifting main body 22 from the collapsed configuration to the assembled configuration is to pivot first and second side panels 40,42 at bend line 38 through a pivot angle of at least about 10 degrees, more preferably at least about 20 degrees, and most preferably in the range of from 30 to 60 degrees. When first and second side panels 40,42 are pivoted relative to one another in this manner, first and second side panels 40,42 form a generally V-shaped trough. The next step in shifting main body 22 from the collapsed configuration to the assembled configuration is to use the first and second outer and inner end panels 46,48,52,54 to connect first and second side panels 40,42 to one another, thereby supporting first and second side panels 40,42 in the generally V-shaped configuration. When shifting main body 22 from the collapsed configuration to the assembled configuration, first and second outer and inner end panels 46,48,52,54 are pivoted relative to first and second side panels 40,42 at bend lines 26,28,32,34 (shown in FIG. 3), respectively, through a pivot angle of at least about 30 degrees, more preferably at least about 60 degrees, and most preferably in the range of from 75 to 105 degrees. It is preferred for main body 22 to have a minimum thickness when in the assembled configuration that is at least twice the maximum thickness of main body 22 in the collapsed configuration, more preferably at least four times maximum thickness of main body 22 in the collapsed configuration.

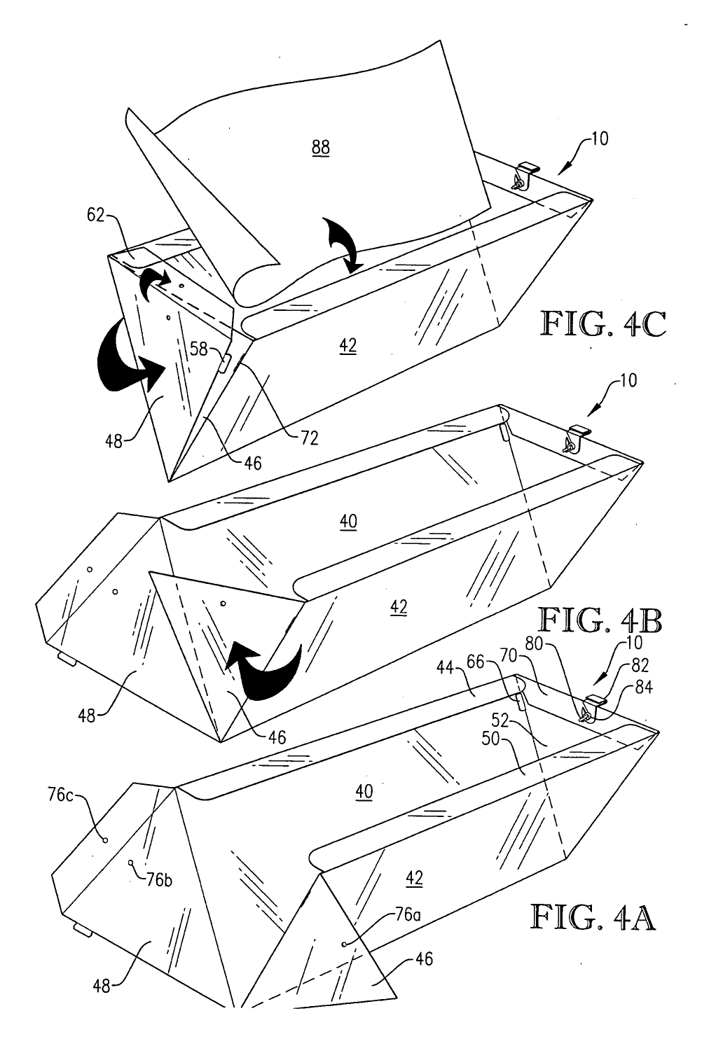

FIGS. 4A, 4B, and 4C illustrate the manner in which first inner end panel 46 and first outer end panel 48 can be folded relative to one another and coupled to one another so that they support first and second side panels 40,42 relative to one another. As shown in FIG. 4B, first inner end panel 46 is first folded into a position where it extends substantially perpendicular to second side panel 42. As shown in FIG. 4C, first outer end panel 48 is then folded over first inner end panel 46 so that first connection tab 58 is extended into first slot 72. When first connection tab 58 is received in first slot 72, first inner and outer end panels 46,48 extend substantially perpendicular to first and second side panels 40,42. After first connection tab 58 has been received in first slot 72, first overlap tab 62 can be folded over the top portion of first inner end panel 46 so that the top portion of first inner end panel 46 is received between first overlap tab 62 and first outer end panel 48. Once first overlap tab 62 has been folded over first inner end panel 46, first openings 76a,b,c are substantially aligned with one another. Although the assembly of only the first end of display system 10 is discussed above, it should be understood that both ends of the display system are assembled in substantially the same manner. FIG. 4A also shows that first and second side flanges 44,50 should be folded relative to first and second side panels 40,42, respectively, until side flanges 44,50 extend substantially parallel to the top edges of the first and second ends. In this configuration, side flanges 44,50 help strengthen side panels 40,42.

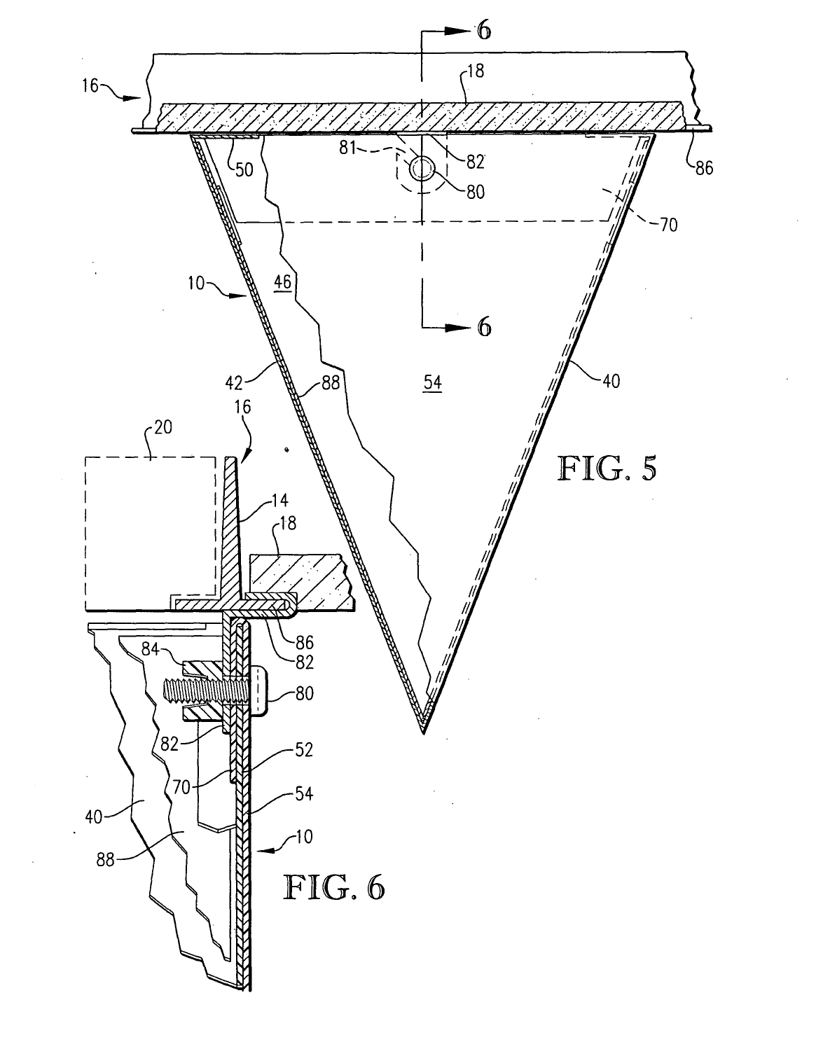

Referring to FIGS. 4 through 6, when second openings 78a,b,c are substantially aligned with one another, a fastener (such as a bolt 80, shown in FIG. 6) can be extended therethrough. After extending the fastener through second openings 78a,b,c, the fastener can be extended through an opening 81 (shown in FIG. 5) in a hook 82 (shown in FIGS. 5 and 6). Thereafter, the fastener can be fixed (e.g., by a wing nut 84) in opening 81 of hook 82 and second openings 78a,b,c so that second outer end panel 54, second inner end panel 52, second overlap tab 70, and hook 82 are rigidly coupled to one another by the fastener. Referring to FIG. 4C, prior to coupling display system 10 to suspended ceiling 16, a translucent sheet 88 with an image to be displayed formed thereon can be inserted into main body 22. Alternatively, translucent sheet 88 can be eliminated if main body 22 has a translucent image to be displayed formed thereon.

As shown in FIGS. 5 and 6, once display system 10 has been shifted and locked into the assembled configuration, display system 10 can be coupled to a structural member 14 of a suspended ceiling 16 by attaching hook 82 to a flange 86 of ceiling support member 14. This can be done for both ends of display system 10 so that display system 10 extends across light fixture 20. Ceiling panel 18 of suspended ceiling 16 can rest on the top of hook 82 to thereby aid in holding display system 10 in place.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as it pertains to any apparatus not materially departing from but outside the literal scope of the invention as set forth in the following claims.

1. A backlit display system comprising:
first and second light-transmissive side panels hingedly coupled to one another along a juncture;
a first outer end panel hingedly coupled to one of the side panels proximate a first end of the juncture; and
a second outer end panel hingedly coupled to one of the side panels proximate a second end of the juncture.

2. The backlit display system of claim 1,
said first and second side panels forming a generally V-shaped trough.

3. The backlit display system of claim 1,
said first and second end panels coupling the first and second side panels to one another proximate the first and second ends of the juncture.

4. The backlit display system of claim 1,
said first and second outer end panels extending substantially perpendicular to the first and second side panels.

5. The backlit display system of claim 1; and
a first inner end panel hingedly coupled to one of the side panels proximate the first end of the juncture; and
a second inner end panel hingedly coupled to one of the side panels proximate the second end of the juncture,
said first inner and outer end panels being hingedly coupled to opposite side panels,
said second inner and outer end panels being hingedly coupled to opposite side panels.

6. The backlit display system of claim 5,
said first and second inner and outer end panels coupling the first and second side panels to one another proximate the first and second ends of the juncture,
said first and second inner and outer end panels extending substantially perpendicular to the first and second side panels.

7. The backlit display system of claim 5; and
a first overlap tab hingedly coupled to the first outer end panel; and
a second overlap tab hingedly coupled to the second outer end panel,
at least a portion of said first inner end panel being received between the first outer end panel and the first overlap tab,
at least a portion of said second inner end panel being received between the second outer end panel and the second overlap tab.

8. The backlit display system of claim 7,
said first outer end panel, said first inner end panel, and said first overlap tab defining aligned first openings,
said second outer end panel, said second inner end panel, and said second overlap tab defining aligned second openings.

9. The backlit display system of claim 8; and
a first fastener extending through the first openings to thereby couple the first outer end panel, the first inner end panel, and the first overlap tab to one another,
a second fastener extending through the second openings to thereby couple the second outer end panel, the second inner end panel, and the second overlap tab to one another.

10. The backlit display system of claim 9; and
a first hook coupled to the first outer end panel, first inner end panel, and first overlap tab by the first fastener,
a second hook coupled to the second outer end panel, second inner end panel, and second overlap tab by the second fastener.

11. The backlit display system of claim 5; and
a first connection tab hingedly coupled to one of the first inner and outer end panels;
a first connection slot defined in the other of the first inner and outer end panels;
a second connection tab hingedly coupled to one of the second inner and outer end panels; and
a second connection slot defined in the other of the second inner and outer end panels,
said first and second connection tabs being received in the first and second connection slots, respectively.

12. The backlit display system of claim 1; and
a first side flange hingedly coupled to the first side panel and extending substantially parallel to the direction of extension of the juncture; and
a second side flange hingedly coupled to the second side panel and extending substantially parallel to the direction of extension of the juncture,
said first side flange extending in a direction which is transverse to the direction of extension of the first side panel,
said second side flange extending in a direction which is transverse to the direction of extension of the second side panel.

13. The backlit display system of claim 1,
said display system being shiftable between a collapsed configuration and an assembled configuration,
said side panels extending from the juncture at an angle of less than 10 degrees relative to one another when the display system is in the collapsed configuration,
said side panels extending from the juncture at an angle of greater than 10 degrees relative to one another when the display system is in the assembled configuration.

14. The backlit display system of claim 13,
said first and second side panels forming a generally V-shaped trough when the display system is in the assembled configuration,
said first and second outer end panels extending between and coupled to the first and second side panels when the display system is in the assembled configuration, thereby supporting the side panels relative to one another.

15. The backlit display system of claim 13,
said end panels being folded over the side panels when the display system is in the collapsed configuration.

16. The backlit display system of claim 13,
said end panels being disposed between the side panels when the display system is in the collapsed configuration.

17. The backlit display system of claim 13,
said display system having a maximum thickness of less than about 4 inches when in the collapsed configuration.

18. The backlit display system of claim 13,
said display system having a minimum thickness when in the assembled configuration that is at least twice the maximum thickness of the display system when in the collapsed configuration.

19. A method of displaying information, said method comprising the steps of:
(a) shifting a display system from a substantially collapsed configuration to an assembled configuration, said assembled. display system including a generally V-shaped trough and a pair of end panels hingedly coupled to generally opposite ends of the trough; and
(b) mounting the assembled display system on a support structure surrounding a light fixture by fastening the end panels to the support structure.

20. The method of claim 19,
said V-shaped trough including first and second side panels hingedly coupled at a juncture,
step (a) including pivoting the first and second side panels relative to one another through a first pivot angle of at least 10 degrees,
step (a) including pivoting one of the end panels relative to the first side panel through a second pivot angle of at least 30 degrees,
step (a) including pivoting the other of the end panels relative to the second side panel through a third pivot angle of at least 30 degrees.

21. The method of claim 20,
step (a) including pivoting the first and second side panels relative to one another through a first pivot angle of at least 20 degrees,
step (a) including pivoting one of the end panels relative to the first side panel through a second pivot angle of at least 60 degrees,
step (a) including pivoting the other of the end panels relative to the second side panel through a third pivot angle of at least 60 degrees.

22. The method of claim 20,
step (a) including pivoting the first and second side panels relative to one another through a first pivot angle in the range of from 30 to 60 degrees,
step (a) including pivoting one of the end panels relative to the first side panel through a second pivot angle in the range of from 75 to 105 degrees,
step (a) including pivoting the other of the end panels relative to the second side panel through a third pivot angle in the range of from 75 to 105 degrees.

23. The method of claim 19,
step (a) including coupling each of the end panels between the first and second side panels to thereby support the side panels in a generally V-shaped configuration.

24. The method of claim 19,
step (a) including coupling a hook to each of the end panels.

25. The method of claim 24,
step (b) including coupling the hooks to the support structure.

26. A method of making a backlit display system, said method comprising the steps of:
(a) providing a display body integrally formed from a substantially flat sheet of light-transmissive material, said display body comprising a generally rectangular main panel and first and second end panels extending from generally opposite ends of the main panel;
(b) folding the display body along a main bend line extending through the main panel to thereby manipulate the main panel into a generally V-shaped trough having a first side panel and a second side panel, said first and second end panels extending from generally opposite ends of the trough;
(c) folding the first and second end panels so that the first and second end panels extend substantially perpendicular to the first and second side panels;
(d) using the first end panel to couple the first and second side panels to one another at one end of the trough; and
(e) using the second end panel to couple the first and second side panels to one another at the other end of the trough.

27. The method of claim 27; and
(f) coupling a first hook to the first end panel; and
(g) coupling a second hook to the second end panel.
